(19) United States
(12) Patent Application Publication
(10) Pub. No.: US 2025/0180906 A1
(43) Pub. Date: Jun. 5, 2025

(54) DIMMABLE FILTER ON LIGHT GUIDE COVER GLASS

(71) Applicant: Snap Inc., Santa Monica, CA (US)

(72) Inventors: Vaibhav Mathur, Playa Vista, CA (US); Amit Singh, Los Angeles, CA (US); Stephen Andrew Steger, Los Angeles, CA (US)

(21) Appl. No.: 18/959,312

(22) Filed: Nov. 25, 2024

Related U.S. Application Data
(60) Provisional application No. 63/605,302, filed on Dec. 1, 2023.

(51) Int. Cl. G02B 27/01

(52) U.S. Cl. CPC G02B 27/0172; G02B 2027/0118; G02B 2027/013; G02B 2027/0178

(57) ABSTRACT

An augmented reality headset can include a headset frame wearable by a user. A light guide disposed in or on the headset frame can direct projector light to an eye of the user over at least a portion of a field of view of the eye. A cover glass can be disposed in or on the headset frame such that the light guide is disposed between the cover glass and the eye of the user when the headset frame is worn by the user. The field of view of the eye can extend through at least a portion of the cover glass. A dimmable filter can be disposed on, optionally laminated to, a surface of the cover glass, optionally between the cover glass and the light guide. The light guide, the dimmable filter, and the cover glass can optionally be parallel layers of a layered structure.

### CLAIM OF PRIORITY

This application claims the benefit of priority to U.S. Provisional Application Ser. No. 63/605,302, filed on Dec. 1, 2023, which is incorporated herein by reference in its entirety.

### FIELD OF THE DISCLOSURE

The present disclosure relates generally to eyewear, such as augmented reality (AR) headsets.

### BACKGROUND OF THE DISCLOSURE

Augmented reality (AR) headset displays can be partially transparent. An AR headset can present visual information to a user, which can be superimposed on the user's view of the user's surroundings. There is ongoing effort to improve AR headsets.

### BRIEF DESCRIPTION OF THE DRAWINGS

FIG. 1 shows a perspective view of an example of an augmented reality headset.

FIG. 2 shows the augmented reality headset from the perspective of a user.

FIG. 3 shows a perspective view of the left projector, the light, and the left near eye display of the augmented reality headset of FIGS. 1 and 2.

FIG. 4 shows a perspective view of a portion of the augmented reality headset of FIGS. 1 and 2.

FIG. 5 shows an exploded view of the right near eye display of the augmented reality headset of FIGS. 1 and 2.

FIG. 6 shows an exploded view of the dimmer subassembly of the left near eye display of the augmented reality headset of FIGS. 1 and 2.

FIG. 7 shows a flow chart of an example of a method for assembling an augmented reality headset.

### DETAILED DESCRIPTION

An augmented reality headset can include a headset frame wearable by a user. A light guide disposed in or on the headset frame can direct projector light to an eye of the user over at least a portion of a field of view of the eye. A cover glass can be disposed in or on the headset frame such that the light guide is disposed between the cover glass and the eye of the user when the headset frame is worn by the user. The field of view of the eye can extend through at least a portion of the cover glass. A dimmable filter can be disposed on, optionally laminated to, a surface of the cover glass, optionally between the cover glass and the light guide. The light guide, the dimmable filter, and the cover glass can optionally be parallel layers of a layered structure.

Forming the augmented reality headset in this manner can simplify handling and assembly of the optical components of the augmented reality headset, can allow greater flexibility in accommodating designs that include compound curvatures of the optical components, and/or can reduce the potential for contamination of the optical components.

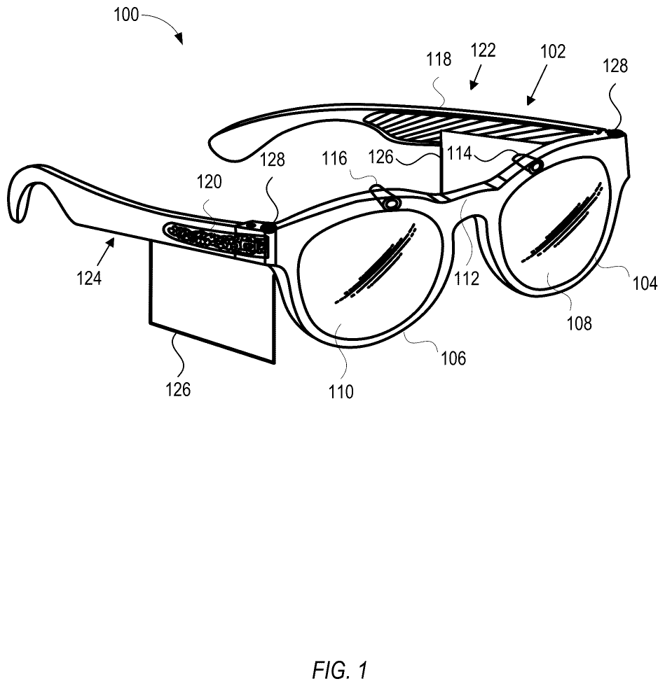

FIG. 1 shows a perspective view of an example of an augmented reality headset 100. The augmented reality headset 100 can include a headset frame 102 that can be wearable by a user. The headset frame 102 can be made from any suitable material such as plastic or metal, including any suitable shape memory alloy.

The headset frame 102 can include a first or left optical element holder 104, such as a display or lens holder. The left optical element holder 104 can support a first or left optical element 108, such as a lens, a display, and/or a display assembly. The headset frame 102 can include a second or right optical element holder 106, such as a display or lens holder. The right optical element holder 106 can support a second or right optical element 110, such as a lens, a display, and/or a display assembly. The headset frame 102 can include a bridge 112 that connects the left optical element holder 104 to the right optical element holder 106. The headset frame 102 can include a left arm or temple piece 122 and a right arm or temple piece 124. The headset frame 102 can optionally be formed from a single piece of material so as to have a unitary or integral construction.

The augmented reality headset 100 can include a computing device, such as a controller 120. The headset frame 102 can carry the controller 120. For example, the controller 120 can be suitably sized and shaped to be at least partially disposed in one of the temple piece 122 or the temple piece 124. The controller 120 can include one or more processors with memory, wireless communication circuitry, and a power source. The controller 120 can include low-power circuitry, high-speed circuitry, and a display processor. The controller 120 can include a battery 118 or other suitable portable power supply. The battery 118 can be disposed in one of the left temple piece 122 or the right temple piece 124. The controller 120 can be disposed in the other of the left temple piece 122 or the right temple piece 124. The controller 120 can be electrically coupled to the battery 118. The augmented reality headset 100 can include a connector or port (not shown) suitable for charging the battery 118. The augmented reality headset 100 can include a wireless receiver, transmitter or transceiver (not shown). The controller 120 can include a processor, memory that includes instructions that, when executed by the processor, cause the processor to perform the one or more tasks described herein.

The augmented reality headset 100 can include one or more input sensors, such as cameras, biometric sensors, location sensors, and/or motion sensors. In the configuration of FIG. 1, the augmented reality headset 100 can include a first or left camera 114 and a second or right camera 116. The one or more input sensors can provide video frame data for use by the augmented reality headset 100 to extract three-dimensional (3D) information from a real-world scene.

The augmented reality headset 100 can include one or more input/output devices, such as touchpads and/or buttons, to receive user input. For example, the augmented reality headset 100 can include a touchpad 126 mounted to or integrated with one or both of the left temple piece 122 and right temple piece 124. The touchpad 126 can be approximately parallel to a user's temple when the augmented reality headset 100 is worn. The augmented reality headset 100 can include one or more buttons 128 disposed on outer upper edges of the left optical element holder 104 and/or the right optical element holder 106. Other suitable locations and orientations can also be used.

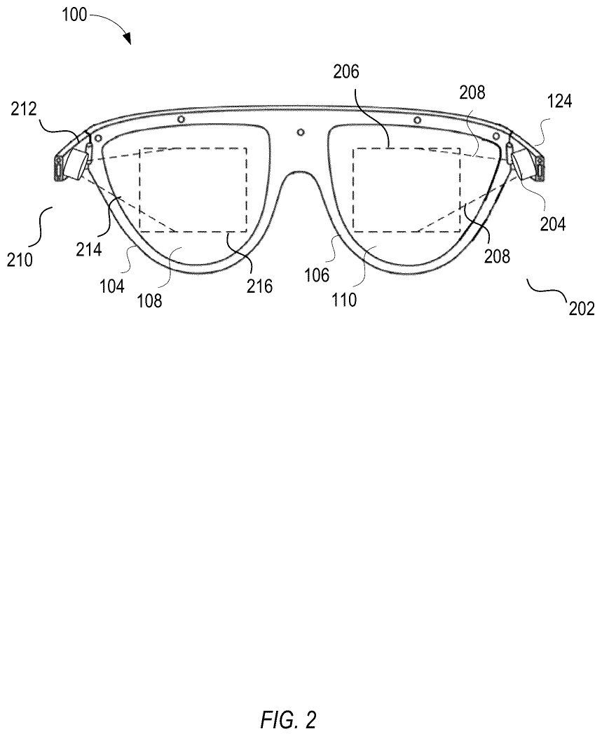

FIG. 2 shows the augmented reality headset 100 from the perspective of a user. The left optical element holder 104 securely supports the left optical element 108. The right optical element holder 106 securely supports the right optical element 110. For clarity, FIG. 2 omits several elements shown in FIG. 1.

The augmented reality headset 100 can include a left forward optical assembly 210, which includes a left projector 212 to emit light 214. The augmented reality headset 100 can include a left near eye display 216 to receive the light 214 and redirect the light 214 toward a left eye of the user. The light 214 can provide an image on or in the left optical element 108 that overlays the view of the real world seen by the user.

Similarly, the augmented reality headset 100 can include a right forward optical assembly 202, which includes a right projector 204 to emit light 208. The augmented reality headset 100 can include a right near eye display 206 to receive the light 208 and redirect the light 208 toward a right eye of the user. The light 208 can provide an image on or in the right optical element 110 that overlays the view of the real world seen by the user.

The combination of a GPU, the left forward optical assembly 210, the left optical element 108, the right forward optical assembly 202, and the right optical element 110 provide an optical engine of the augmented reality headset 100. The augmented reality headset 100 uses the optical engine to generate an overlay that can be superimposed on the real-world view of the user including display of a 3D user interface to the user of the augmented reality headset 100.

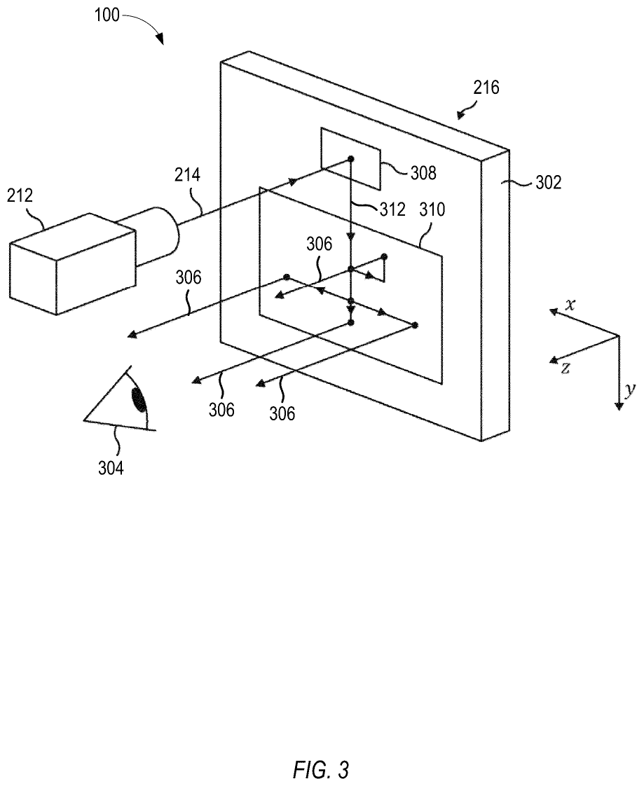

FIG. 3 shows a perspective view of the left projector 212, the light 214 (represented in FIG. 3 as a single ray), and the left near eye display 216 of the augmented reality headset 100 of FIGS. 1 and 2. The corresponding elements for the right eye can have a similar construction and function.

The left near eye display 216 can include a light guide 302, also known as a waveguide. The light guide 302 can guide light via repeated total internal reflections from opposing light-guiding surfaces of the light guide 302. In the configuration of FIG. 3, the light guide 302 can be configured as a planar waveguide or a slab waveguide, such as disposed in the x-y plane. The light-guiding surfaces can be generally flat or planar surfaces that are parallel to each other and extend in the x-y plane. One of the light-guiding surfaces can face an eye 304 of the user. The other of the light-guiding surfaces can face away from the eye 304 of the user.

The light guide 302 can include one or more diffractive and/or reflective structures, which can receive the light 214 from the left projector 212, redirect the light internally within the light guide 302, and extract the light from the light guide 302 to form exiting light 306. For example, the light guide 302 can include one or more diffraction gratings and/or diffraction grating regions, such as a single diffraction grating structure that has individual regions that can function as if they were separate diffraction gratings. The light guide 302 can include one or more reflective structures, such as mirrors, prisms, and/or reflective gratings. The light guide 302 can optionally include one or more light-focusing (or collimating-changing) optical elements, such as lenses. Any or all of these structures or elements can be included on one or both light-guiding surfaces of the light guide 302 or in an interior of the light guide 302.

In the configuration of FIG. 3, the light guide 302 can include an input grating 308, which can receive the light 214 from the left projector 212 and direct the light into the light guide 302 to form light 312. The light guide 302 can include an output grating 310, which can receive the light 312, split and redirect the light internally to extend over a relatively large area (compared to the input grating 308), and direct the light out of the light guide 302 to form the exiting light 306. The redirections and splitting can occur from multiple (sequential) interactions with a single diffraction grating, or from sequential interactions with different gratings that are disposed within the surface area of the output grating 310. For example, a light ray can totally internally reflect from one light-guiding surface of the light guide 302, interact with diffractive features on the output grating 310 on the opposing light guide surface, totally internally reflect from the light-guiding surface of the light guide 302, interact with the diffractive features, and so forth. The interactions with the diffractive features on the output grating 310 can cause internal rays or internal light beams in the light guide 302 to change direction within the light guide 302. Eventually, the interactions with the diffractive features can cause the internal rays or internal light beams to exit the light guide 302 to propagate toward the eye 304 of the user.

In some examples, the light guide 302 can be configured to operate at infinite conjugates. For example, the left projector 212 may project light 214 that forms an image infinitely far away, so that the light 214 would appear in focus on a screen placed relatively far from the left projector 212. Similarly, the output grating 310 may direct the exiting light 306 toward the eye in such a manner that the image appears to be infinitely far away to the eye 304 of the user. For such an infinite-conjugate arrangement, angles in the space of the light that enters and exits the light guide 302 can correspond uniquely to image locations in the image. For example, the propagation angles of the light 214 can map uniquely to the propagation angles of the exiting light 306, which in turn can map uniquely to the image locations in the image at the retina of the eye 304 of the user.

The light guide 302 can make use of this infinite-conjugate relationship to perform so-called “pupil mapping.” The left projector 212 can be configured to have an exit pupil that coincides with the input grating 308. The internal splitting and redirections within the output grating 310 can effectively expand a surface area of the exit pupil, while maintaining the unique mapping of propagation angle to image location for light in the pupil. The size of the output grating 310 (e.g., the surface area over which the exiting light 306 emerges from the output grating 310) can be larger than a pupil of the eye 304 of the user, so that if the pupil of the eye 304 moves, such as caused by the user changing a gaze direction, the amount of light entering the pupil of the eye 304 may not vary significantly, and the user may not perceive a change in brightness of the image.

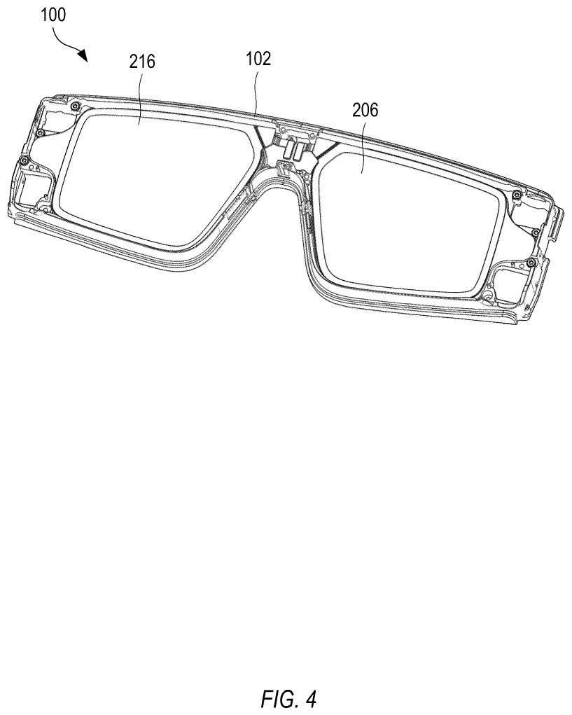

FIG. 4 shows a perspective view of a portion of the augmented reality headset 100 of FIGS. 1 and 2. The augmented reality headset 100 can include the headset frame 102, which can be wearable by a user. The augmented reality headset 100 can include the left near eye display 216 and the right near eye display 206, as disposed in the headset frame 102.

In the example of FIG. 4, the left near eye display 216 and the right near eye display 206 can each include optical elements that are attached to one another, such as by lamination or another suitable technique. The optical elements can form a layered structure. The layered structure can be relatively rigid, so that a technician can position the layered structure as needed during assembly of the augmented reality headset 100. The layered structure can include at least a light guide, a cover glass, and a dimmable filter, as described in detail below.

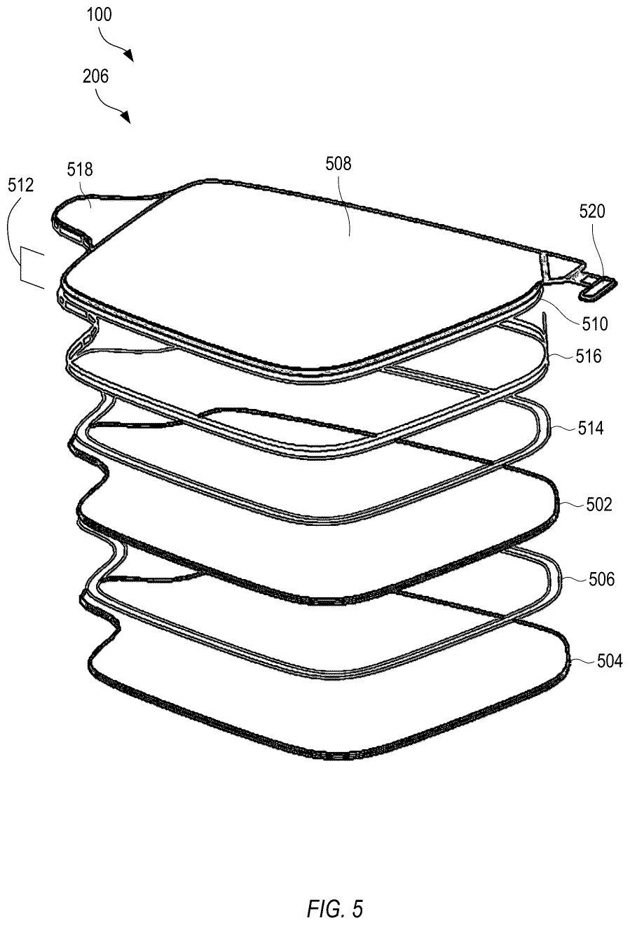

FIG. 5 shows an exploded view of the right near eye display 206 of the augmented reality headset 100 of FIGS. 1 and 2. In its assembled (e.g., non-exploded) state, the right near eye display 206 can be disposed in the headset frame 102 of the augmented reality headset 100. In the view of FIG. 5, the right eye of the user is positioned at a bottom of FIG. 5. Specifically, environmental light that propagates from the user's surroundings to the user's right eye propagates in a generally downward direction in FIG. 5, sequentially through the elements shown in FIG. 5.

The right near eye display 206 of the augmented reality headset 100 can include one, two, three, or more than three light guides disposed in or on the headset frame. The light guide or light guides can direct projector light to an eye of the user over at least a portion of a field of view of the eye. The light guide or light guides can be similar in structure and function to the light guide 302 of FIG. 3.

In the example of FIG. 5, the right near eye display 206 can include a first light guide 502, which can guide light having a first wavelength, a first color, or a first combination of wavelengths or colors. For example, the first light guide 502 can guide light that includes red light and green light. Other color schemes can also be used.

In the example of FIG. 5, the right near eye display 206 can further include a second light guide 504, which can guide light having a second wavelength, a second color, or a second combination of wavelengths or colors. For example, the second light guide 504 can guide light that includes blue light and green light. Other color schemes can also be used. In the example of FIG. 5, the light from the first light guide 502 (e.g., the red light and green light) can pass through the second light guide 504 to the eye of the user.

The second light guide 504 can be adhered to the first light guide 502 by a first adhesive layer 506 of pressure-sensitive adhesive applied around a perimeter of the second light guide 504 or a perimeter of the first light guide 502. The first adhesive layer 506 can extend around a perimeter of a clear aperture of the first light guide 502 and a clear aperture of the second light guide 504, and can therefore remain outside a field of view of the eye.

The right near eye display 206 of the augmented reality headset 100 can include a cover glass 508 disposed in or on the headset frame 102. The cover glass 508 can face away from the eye of the user when the headset frame 102 is worn. In some examples, the cover glass 508 can be the optical element that is farthest away from the eye when the headset frame 102 is worn, so that the cover glass 508 can protect the other optical elements of the right near eye display 206. The first light guide 502 can be disposed between the cover glass 508 and the eye of the user when the headset frame 102 is worn by the user. The second light guide 504 can be disposed between the cover glass 508 and the eye of the user when the headset frame 102 is worn by the user. The field of view of the eye can extend through at least a portion of the cover glass 508. In some examples, the cover glass 508 can be rigid, and can mechanically support other optical elements and/or films that are attached to the cover glass 508.

The right near eye display 206 of the augmented reality headset 100 can include a dimmable filter 510 disposed on the cover glass 508. The field of view of the eye can extend through at least a portion of the dimmable filter 510. The dimmable filter 510 and the cover glass 508, together, can form a dimmer subassembly 512.

The dimmer subassembly 512 can be adhered to the first light guide 502 by a second adhesive layer 514 of pressure-sensitive adhesive applied around a perimeter of the first light guide 502 or a perimeter of the dimmer subassembly 512. The second adhesive layer 514 can extend around a perimeter of a clear aperture of the first light guide 502 and a clear aperture of the dimmer subassembly 512, and can therefore remain outside the field of view of the eye.

The right near eye display 206 of the augmented reality headset 100 can include an edge-blackening coating 516 that is opaque and can absorb most or all incident (stray) light. The edge-blackening coating 516 can be applied to a perimeter of the first light guide 502, the second light guide 504, the dimmable filter 510, and/or the cover glass 508.

The right near eye display 206 can include an input tab 518 that can face away from a (left-right) center of the headset frame 102 (FIG. 4). When assembled in the headset frame 102 (FIG. 4), the input tab 518 can align with the projector and receive projector light from the projector. Each light guide can include a respective input grating in the input tab 518, which can couple at least some projector light into the light guide.

The right near eye display 206 can include an electrical tab 520. In the configuration of FIG. 5, the electrical tab 520 can be located opposite the input tab 518. In the configuration of FIG. 5, the electrical tab 520 can face toward the (left-right) center of the headset frame 102 (FIG. 4), optionally at or near a nosepiece of the headset frame 102. Locating the electrical tab 520 to point toward the center of the headset frame 102 can allow a central set of electrical leads in the headset frame 102, such as in the nosepiece, to connect to both the left near eye display 216 and the right near eye display 206.

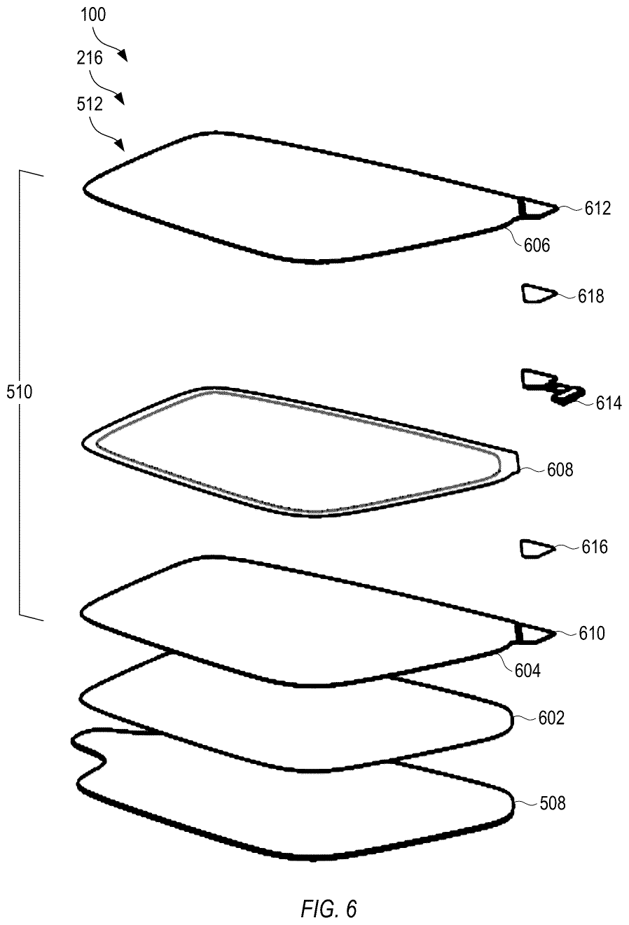

FIG. 6 shows an exploded view of the dimmer subassembly 512 of the left near eye display 216 of the augmented reality headset 100 of FIGS. 1 and 2. In its assembled (e.g., non-exploded) state, the left near eye display 216 can be disposed in the headset frame 102 of the augmented reality headset 100. In the view of FIG. 6, the left eye of the user is positioned at a top of FIG. 6. Specifically, environmental light that propagates from the user's surroundings to the user's left eye propagates in a generally upward direction in FIG. 6, sequentially through the elements shown in FIG. 6.

The dimmer subassembly 512 of the left near eye display 216 of the augmented reality headset 100 can include the dimmable filter 510 disposed on the cover glass 508. An optically clear adhesive layer 602 can adhere or laminate the dimmable filter 510 to the cover glass 508. The field of view of the eye can extend through at least a portion of the dimmable filter 510.

The dimmable filter 510 can include a first dimmer substrate 604, which can be laminated to the cover glass 508 via the optically clear adhesive layer 602. The dimmable filter 510 can include a second dimmer substrate 606, which can be adhered to the first dimmer substrate 604 via a dimmer adhesive layer 608. The dimmer adhesive layer 608 can extend around a perimeter of a clear aperture of the dimmable filter 510, such that dimmer adhesive layer 608 may not obstruct the field of view of the user's eye.

The first dimmer substrate 604 can include a first dimmer substrate electrical connection portion 610 in a region of the first dimmer substrate 604 that corresponds to the electrical tab 520 (FIG. 5). The second dimmer substrate 606 can include a second dimmer substrate electrical connection portion 612 in a region of the second dimmer substrate 606 that corresponds to the electrical tab 520 (FIG. 5). The electrical connections can be located away outside the clear aperture of the optical elements of the dimmable filter 510 and can therefore be located outside the field of view of the eye.

The dimmable filter 510 can include a dimmer flexible printed circuit 614 to form the electrical connections to and from the first dimmer substrate 604 and to and from the second dimmer substrate 606. The dimmer flexible printed circuit 614 can attach to the first dimmer substrate electrical connection portion 610 of the first dimmer substrate 604 via a first anisotropic conductive film 616. The dimmer flexible printed circuit 614 can attach to the second dimmer substrate electrical connection portion 612 of the second dimmer substrate 606 via a second anisotropic conductive film 618. Other suitable electrical connection techniques can also be used.

In some examples, the dimmable filter 510 can be disposed between the cover glass 508 and the first light guide 502. In some examples, the dimmable filter 510 can be disposed between the cover glass 508 and the second light guide 504. For example, when the headset frame 102 is worn by the user, a ray of environmental light in the field of view of the eye can pass sequentially from an environment surrounding the user, through the cover glass 508, then through the dimmable filter 510, then through the first light guide 502, to the eye. Similarly, when the headset frame 102 is worn by the user, a ray of environmental light in the field of view of the eye can pass sequentially from an environment surrounding the user, through the cover glass 508, then through the dimmable filter 510, then through the second light guide 504, to the eye.

By locating the optical elements in this manner, guided light that is extracted from the first light guide 502 may not be dimmed by the dimmable filter 510, which can increase the perceived brightness of the extracted light during operation of the augmented reality headset 100. In addition, locating the optical elements in this manner can use the cover glass 508 to protect the elements of the dimmable filter 510. By locating the optical elements in this manner, guided light that is extracted from the second light guide 504 may not be dimmed by the dimmable filter 510, which can increase the perceived brightness of the extracted light during operation of the augmented reality headset 100.

In addition, a ray of the projector light in the field of view of the eye, such as light 214 or light 208, can pass from the light guide, such as the first light guide 502 or the second light guide 504, to the eye without passing through the dimmable filter 510 or the cover glass 508. By locating the optical elements such that the dimmable filter 510 may not dim the projector light, the augmented reality headset 100 may avoid unnecessary dimming of the image projected to the user.

In some examples, the dimmable filter 510 can be disposed directly adjacent to a light-guiding surface of the light guide, such as the first light guide 502 or the second light guide 504, without any intervening optical elements disposed between the dimmable filter 510 and the light-guiding surface of the light guide. In the specific geometry of FIG. 5, a bottommost surface of the dimmable filter 510 can be disposed directly adjacent to a light-guiding surface of the first light guide 502, without any intervening optical elements disposed between the dimmable filter 510 and the light-guiding surface of first light guide 502. Positioning the optical elements in this manner can simplify handling of the elements during assembly of the augmented reality headset 100, and can reduce the potential for contamination during assembly of the augmented reality headset 100.

In some examples, the cover glass 508 and the dimmable filter 510 can be in contact over a surface area corresponding to the field of view of the eye. Such contact can mechanically support the dimmable filter 510 and can help ensure uniformity in the displayed image over the field of view of the eye.

In some examples, the dimmable filter 510 can be in contact with a light-guiding surface of the light guide, such as the first light guide 502 or the second light guide 504. In the specific geometry of FIG. 5, a bottommost surface of the dimmable filter 510 can be in contact with a topmost surface of the first light guide 502. Such contact can reduce the potential for contamination during assembly of the augmented reality headset 100.

In some examples, the dimmable filter 510 can be laminated to a surface of the cover glass 508 using an optically clear adhesive. Using an optical clear adhesive in this manner can help reduce a number of air/surface interfaces present in an optical path between the surroundings and the eye of the user, which can increase the perceived brightness of the surroundings for the user.

In some examples, the first light guide 502, the dimmable filter 510, and the cover glass 508 comprise parallel layers of a layered structure. In some examples, the second light guide 504, the dimmable filter 510, and the cover glass 508 comprise parallel layers of a layered structure. In some examples, the first light guide 502, the second light guide 504, the dimmable filter 510, and the cover glass 508 comprise parallel layers of a layered structure. Forming a layered structure in this manner can simplify handling of the optical elements during assembly of the augmented reality headset 100.

In some examples, the first light guide 502, the dimmable filter 510, and the cover glass 508 have corresponding compound curvatures. In some examples, the second light guide 504, the dimmable filter 510, and the cover glass 508 have corresponding compound curvatures. In some examples, the first light guide 502, the second light guide 504, the dimmable filter 510, and the cover glass 508 have corresponding compound curvatures. Because these optical elements can have compound curvature, these optical elements can be particularly well-suited for inclusion in a layered structure, as described above. More specifically, the compound curvature might complicate other assembly and attachment techniques in which the optical elements are spaced apart. In addition, the compound curvature can allow for greater flexibility in the design of the optical elements, compared to planar arrangements for these optical elements.

In some examples, the cover glass 508 can be substantially rigid and can mechanically support the dimmable filter 510. Using the cover glass 508 for support in this manner can provide greater flexibility in the design and construction of the dimmable filter 510.

In some examples, such as the configuration of FIG. 5, the augmented reality headset 100 can include multiple light guides, each providing light of a different spectral profile (e.g., having a different color, a different wavelength, and/or a different spectral range). As a specific example, the first light guide 502 can direct blue light and some green light toward the eye of the view. In some examples, the first light guide 502 can receive the blue light and the green light from multiple projectors, each projector projecting light at a different color, wavelength, or spectral region. In other examples, the first light guide 502 can receive the blue light and the green light from a single projector and suitable spectral filters. Similarly, the second light guide 504 can direct red light and some green light toward the eye of the view. In some examples, the second light guide 504 can receive the red light and the green light from multiple projectors, each projector projecting light at a different color, wavelength, or spectral region. In other examples, the second light guide 504 can receive the red light and the green light from a single projector and suitable spectral filters. For configuration in which the augmented reality headset 100 includes multiple light guides, a first light guide can receive projector light having a first spectral profile, and a second light guide can receive projector light having a second spectral profile that differs from the first spectral profile.

In some examples, the dimmable filter 510 can be pixilated. For example, the dimmable filter 510 can include a plurality of filter regions that have respective controllable transparencies. In some examples, the plurality of filter regions includes two, three, four, or more than four regions. In some examples, the plurality of filter regions can include enough pixels to form a low-resolution or a high-resolution image for the user. In some examples, the augmented reality headset 100 can include a controller, such as controller 120. The controller can control the transparencies of the plurality of the filter regions. The transparencies can be controlled independent of one another.

In some examples, the augmented reality headset 100 can include a light projector, such as left projector 212 and/or the right projector 204. The projector can provide the projector light, such as the light 214 or the light 208. The projector light can represent an image. The controller can control the transparencies of the plurality of filter regions based at least in part on the image. For example, the image can include an object. The controller can increase a contrast of the object by decreasing the transparency of the dimmable filter in at least one filter region corresponding to a location of the object in the image.

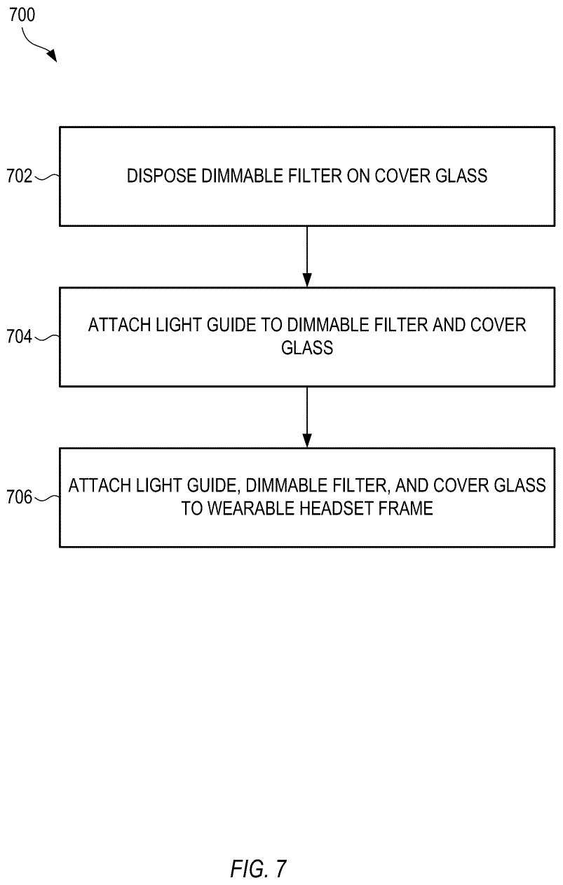

FIG. 7 shows a flow chart of an example of a method 700 for assembling an augmented reality headset, such as augmented reality headset 100, or others. The method 700 is but one method for assembling an augmented reality headset. Other suitable methods can also be used.

At operation 702, a dimmable filter, such as dimmable filter 510, can be disposed on a cover glass, such as cover glass 508.

At operation 704, a light guide, such as light guide 302, first light guide 502, and/or second light guide 504, can be attached to the dimmable filter and the cover glass such that the dimmable filter is located between the cover glass and the light guide.

At operation 706, the light guide, the dimmable filter, and the cover glass can be attached to a wearable headset frame, such as headset frame 102. When the headset frame is worn by a user, the light guide is configured to provide projector light to an eye of the user over at least a portion of a field of view of the eye. When the headset frame is worn by a user, the light guide is disposed between the cover glass and the eye of the user. When the headset frame is worn by a user, the field of view of the eye extends through at least a portion of the cover glass and at least a portion of the dimmable filter.

In some examples, disposing the dimmable filter on the cover glass can include laminating the dimmable filter to a surface of the cover glass using an optically clear adhesive.

In some examples, the method 700 can further include forming a layered structure from the light guide, the dimmable filter, and the cover glass.

To further illustrate the systems and related methods disclosed herein, a non-limiting list of examples is provided below. Each of the following non-limiting examples can stand on its own or can be combined in any permutation or combination with any one or more of the other examples.

In Example 1, an augmented reality headset can comprise: a headset frame wearable by a user; a light guide disposed in or on the headset frame and configured to direct projector light to an eye of the user over at least a portion of a field of view of the eye; a cover glass disposed in or on the headset frame such that the light guide is disposed between the cover glass and the eye of the user when the headset frame is worn by the user, the field of view of the eye extending through at least a portion of the cover glass; and a dimmable filter disposed on the cover glass, the field of view of the eye extending through at least a portion of the dimmable filter.

In Example 2, the augmented reality headset of Example 1 can optionally be configured such that the dimmable filter is disposed between the cover glass and the light guide.

In Example 3, the augmented reality headset of any one of Examples 1-2 can optionally be configured such that when the headset frame is worn by the user: a ray of environmental light in the field of view of the eye passes sequentially from an environment surrounding the user, through the cover glass, then through the dimmable filter, then through the light guide, to the eye; and a ray of the projector light in the field of view of the eye passes from the light guide to the eye without passing through the dimmable filter or the cover glass.

In Example 4, the augmented reality headset of any one of Examples 1-3 can optionally be configured such that the dimmable filter is disposed directly adjacent to a light-guiding surface of the light guide without any intervening optical elements disposed between the dimmable filter and the light-guiding surface of the light guide.

In Example 5, the augmented reality headset of any one of Examples 1-4 can optionally be configured such that the cover glass and the dimmable filter are in contact over a surface area corresponding to the field of view of the eye.

In Example 6, the augmented reality headset of any one of Examples 1-5 can optionally be configured such that the dimmable filter is in contact with a light-guiding surface of the light guide.

In Example 7, the augmented reality headset of any one of Examples 1-6 can optionally be configured such that the dimmable filter is laminated to a surface of the cover glass using an optically clear adhesive.

In Example 8, the augmented reality headset of any one of Examples 1-7 can optionally be configured such that the light guide, the dimmable filter, and the cover glass comprise parallel layers of a layered structure.

In Example 9, the augmented reality headset of any one of Examples 1-8 can optionally be configured such that the light guide, the dimmable filter, and the cover glass have corresponding compound curvatures.

In Example 10, the augmented reality headset of any one of Examples 1-9 can optionally be configured such that the cover glass is substantially rigid and mechanically supports the dimmable filter.

In Example 11, the augmented reality headset of any one of Examples 1-10 can optionally be configured such that: the light guide is a first light guide; the projector light is first projector light and has a first spectral profile; the augmented reality headset further includes a second light guide; the first light guide is disposed between the second light guide and the dimmable filter; the field of view of the eye of the user extends through at least part of the second light guide when the headset frame is worn by the user; the second light guide is configured to provide second projector light to the eye of the user over at least the portion of the field of view of the eye; and the second projector light has a second spectral profile that differs from the first spectral profile.

In Example 12, the augmented reality headset of any one of Examples 1-11 can optionally be configured such that: the dimmable filter includes a plurality of filter regions that have respective controllable transparencies; and the augmented reality headset further comprises a controller configured to control the transparencies of the plurality of the filter regions, the transparencies being controlled independent of one another.

In Example 13, the augmented reality headset of any one of Examples 1-12 can optionally further comprise a light projector configured to provide the projector light, the projector light representing an image, the controller being further configured to control the transparencies of the plurality of filter regions based at least in part on the image.

In Example 14, the augmented reality headset of any one of Examples 1-13 can optionally be configured such that: the image includes an object; and the controller is further configured to increase a contrast of the object by decreasing the transparency of the dimmable filter in at least one filter region corresponding to a location of the object in the image.

In Example 15, a method for assembling an augmented reality headset can comprise: disposing a dimmable filter on a cover glass; attaching a light guide to the dimmable filter and the cover glass such that the dimmable filter is located between the cover glass and the light guide; and attaching the light guide, the dimmable filter, and the cover glass to a wearable headset frame, such that when the headset frame is worn by a user: the light guide is configured to provide projector light to an eye of the user over at least a portion of a field of view of the eye; the light guide is disposed between the cover glass and the eye of the user; and the field of view of the eye extends through at least a portion of the cover glass and at least a portion of the dimmable filter.

In Example 16, the method of Example 15 can optionally be configured such that disposing the dimmable filter on the cover glass comprises laminating the dimmable filter to a surface of the cover glass using an optically clear adhesive.

In Example 17, the method of any one of Examples 15-16 can optionally further comprise forming a layered structure from the light guide, the dimmable filter, and the cover glass.

In Example 18, an augmented reality headset can comprise: a headset frame wearable by a user; a light projector disposed in or on the headset frame and configured to provide projector light that represents an image; a light guide disposed in or on the headset frame and configured to direct the projector light to an eye of the user over at least a portion of a field of view of the eye; a cover glass disposed in or on the headset frame such that the light guide is disposed between the cover glass and the eye of the user when the headset frame is worn by the user, the field of view of the eye extending through at least a portion of the cover glass; a dimmable filter laminated to a surface of the cover glass between the cover glass and the light guide, the field of view of the eye extending through at least a portion of the dimmable filter, the light guide being disposed between the dimmable filter and the eye of the user when the headset frame is worn by the user, the dimmable filter including a plurality of filter regions that have respective controllable transparencies; and a controller configured to control the transparencies of the plurality of the filter regions based at least in part on the image.

In Example 19, the augmented reality headset of Example 18 can optionally be configured such that: the image includes an object; and the controller is further configured to increase a contrast of the object by decreasing the transparency of the dimmable filter in at least one filter region corresponding to a location of the object in the image.

In Example 20, the augmented reality headset of any one of Examples 18-19 can optionally be configured such that: the light guide, the dimmable filter, and the cover glass comprise parallel layers of a layered structure; and the light guide, the dimmable filter, and the cover glass have corresponding compound curvatures.

What is claimed is:

1. An augmented reality headset, comprising:
a headset frame wearable by a user;
a light guide disposed in or on the headset frame and configured to direct projector light to an eye of the user over at least a portion of a field of view of the eye;
a cover glass disposed in or on the headset frame such that the light guide is disposed between the cover glass and the eye of the user when the headset frame is worn by the user, the field of view of the eye extending through at least a portion of the cover glass; and
a dimmable filter disposed on the cover glass, the field of view of the eye extending through at least a portion of the dimmable filter.

2. The augmented reality headset of claim 1, wherein the dimmable filter is disposed between the cover glass and the light guide.

3. The augmented reality headset of claim 2, wherein when the headset frame is worn by the user:
a ray of environmental light in the field of view of the eye passes sequentially from an environment surrounding the user, through the cover glass, then through the dimmable filter, then through the light guide, to the eye; and
a ray of the projector light in the field of view of the eye passes from the light guide to the eye without passing through the dimmable filter or the cover glass.

4. The augmented reality headset of claim 2, wherein the dimmable filter is disposed directly adjacent to a light-guiding surface of the light guide without any intervening optical elements disposed between the dimmable filter and the light-guiding surface of the light guide.

5. The augmented reality headset of claim 1, wherein the cover glass and the dimmable filter are in contact over a surface area corresponding to the field of view of the eye.

6. The augmented reality headset of claim 1, wherein the dimmable filter is in contact with a light-guiding surface of the light guide.

7. The augmented reality headset of claim 1, wherein the dimmable filter is laminated to a surface of the cover glass using an optically clear adhesive.

8. The augmented reality headset of claim 1, wherein the light guide, the dimmable filter, and the cover glass comprise parallel layers of a layered structure.

9. The augmented reality headset of claim 1, wherein the light guide, the dimmable filter, and the cover glass have corresponding compound curvatures.

10. The augmented reality headset of claim 1, wherein the cover glass is substantially rigid and mechanically supports the dimmable filter.

11. The augmented reality headset of claim 1, wherein:
the light guide is a first light guide;
the projector light is first projector light and has a first spectral profile;
the augmented reality headset further includes a second light guide;
the first light guide is disposed between the second light guide and the dimmable filter;
the field of view of the eye of the user extends through at least part of the second light guide when the headset frame is worn by the user;
the second light guide is configured to provide second projector light to the eye of the user over at least the portion of the field of view of the eye; and
the second projector light has a second spectral profile that differs from the first spectral profile.

12. The augmented reality headset of claim 1, wherein:
the dimmable filter includes a plurality of filter regions that have respective controllable transparencies; and
the augmented reality headset further comprises a controller configured to control the transparencies of the plurality of the filter regions, the transparencies being controlled independent of one another.

13. The augmented reality headset of claim 12, further comprising a light projector configured to provide the projector light, the projector light representing an image, the controller being further configured to control the transparencies of the plurality of filter regions based at least in part on the image.

14. The augmented reality headset of claim 13, wherein:
the image includes an object; and
the controller is further configured to increase a contrast of the object by decreasing the transparency of the dimmable filter in at least one filter region corresponding to a location of the object in the image.

15. A method for assembling an augmented reality headset, the method comprising:
disposing a dimmable filter on a cover glass;
attaching a light guide to the dimmable filter and the cover glass such that the dimmable filter is located between the cover glass and the light guide; and
attaching the light guide, the dimmable filter, and the cover glass to a wearable headset frame, such that when the headset frame is worn by a user:
the light guide is configured to provide projector light to an eye of the user over at least a portion of a field of view of the eye;
the light guide is disposed between the cover glass and the eye of the user; and
the field of view of the eye extends through at least a portion of the cover glass and at least a portion of the dimmable filter.

16. The method of claim 15, wherein disposing the dimmable filter on the cover glass comprises laminating the dimmable filter to a surface of the cover glass using an optically clear adhesive.

17. The method of claim 15, further comprising forming a layered structure from the light guide, the dimmable filter, and the cover glass.

18. An augmented reality headset, comprising:
a headset frame wearable by a user;
a light projector disposed in or on the headset frame configured to provide projector light that represents an image;
a light guide disposed in or on the headset frame and configured to direct the projector light to an eye of the user over at least a portion of a field of view of the eye;
a cover glass disposed in or on the headset frame such that the light guide is disposed between the cover glass and the eye of the user when the headset frame is worn by the user, the field of view of the eye extending through at least a portion of the cover glass;
a dimmable filter laminated to a surface of the cover glass between the cover glass and the light guide, the field of view of the eye extending through at least a portion of the dimmable filter, the light guide being disposed between the dimmable filter and the eye of the user when the headset frame is worn by the user, the dimmable filter including a plurality of filter regions that have respective controllable transparencies; and
a controller configured to control the transparencies of the plurality of the filter regions based at least in part on the image.

19. The augmented reality headset of claim 18, wherein:
the image includes an object; and
the controller is further configured to increase a contrast of the object by decreasing the transparency of the dimmable filter in at least one filter region corresponding to a location of the object in the image.

20. The augmented reality headset of claim 18, wherein:
the light guide, the dimmable filter, and the cover glass comprise parallel layers of a layered structure; and
the light guide, the dimmable filter, and the cover glass have corresponding compound curvatures.
